(19) United States
(12) Patent Application Publication
(10) Pub. No.: US 2018/0029856 A1
(43) Pub. Date: Feb. 1, 2018

(54) Platform And Method Of Raising A Tire Of A Vehicle

(71) Applicant: CHAIN 'EM UP LLC, Englewood, CO (US)

(72) Inventor: Norman Frank Muth, Lakewood, CO (US)

(73) Assignee: CHAIN 'EM UP LLC, Englewood, CO (US)

(21) Appl. No.: 15/659,211

(22) Filed: Jul. 25, 2017

Related U.S. Application Data
(60) Provisional application No. 62/366,727, filed on Jul. 26, 2016.

(51) Int. Cl. B66F 7/24; B66F 7/26; B66F 7/28

(52) U.S. Cl. CPC B66F 7/243; B66F 7/28; B66F 7/26

(57) ABSTRACT

A platform having a first ramp section and a second ramp section, each of the first and second ramp sections including a bottom surface having cleats and a top surface having a substantially level surface disposed between first and second ramp sections. The top surface includes a level top surface having a pair of recessed portions disposed in spaced apart relation between the first and second ramp sections. A pair of interlocking elements disposed at a junction plane between the pair of recessed portions is provided. The interlocking elements are adapted to lock and unlock to dispose the first and second ramp sections between an operable condition and a storage condition.

This United States Non-Provisional Patent Application claims the benefit of U.S. Provisional Patent Application No. 62/366,727, filed Jul. 26, 2016, hereby incorporated by reference herein.

### I. TECHNICAL FIELD

A platform and methods of making and using a platform for raising one or more tires of a vehicle having multiple wheels on one or more axles.

### II. SUMMARY OF THE INVENTION

A broad object of the invention can be to provide a platform for supporting an inner tire within a set of multiple tires on an axle of a vehicle having one or more sets of multiple tires each on one or more wheels on one or more axles. The platform supports the inner tire above a support surface thereby causing to suspend an outermost tire of the set of multiple tires above the support surface. The platform includes a bottom surface configured to engage the support surface and a top surface, having a substantially level portion, and a first recessed portion capable of partially receiving the inner tire of a first set of the multiple tires each on one or more of the wheels on a first axle of the vehicle. The platform can further include a second recessed portion disposed in the top surface, in which the second recessed portion is capable of partially receiving the inner tire of a second set of the multiple tires each on one or more of the wheels on a second axle of the vehicle.

The platform can further include one or more of: a first ramp coupled to a platform first end or a second ramp coupled to a platform second end, a first set of handholds coupled to the platform first or second sidewall, one or more apertures which each provide a passthrough in the top surface, patterned surface elements disposed on one or more of the top surface, the first recessed portion, the second recessed portion, the first ramp, the second ramp or the bottom surface, and cleats disposed on or extending from the bottom surface.

Additionally, embodiments can, but need not necessarily, comprise first and second platform sections which include a pair of interlockable elements which releasably interconnect to abut the first platform section with the second platform section at a juncture plane. In illustrative embodiments, the pair of interlockable elements include mateable portions of a dovetail joint, mateable flanges and receiving slots or interleavable flanges. Embodiments can, but need not necessarily, include a hinge about which the first platform section and the second platform section rotate between an operable condition in which the first platform section and the second platform section abut at the juncture plane toward a storage condition in which the first platform section and the second platform section abut the bottom surface of the first platform section against the bottom surface of the second platform section.

Another broad object of the invention can be a method of making a platform for supporting an inner tire within a set of multiple tires on an axle of a vehicle having one or more sets of multiple tires each on one or more wheels, each of the wheels on one or more axles, in which the platform supporting the inner tire suspends an outermost tire of the set of multiple tires above a support surface is disclosed. The method includes configuring a bottom surface of a platform to engage a support surface, disposing a first recessed portion in a substantially level portion of a top surface of said platform, the first recessed portion capable of receiving partially therein the inner tire of a first set of said multiple tires each on one or more of the wheels on a first axle of the vehicle. In particular embodiments, the method further includes disposing the first recessed portion in the top surface of the platform as an arcuate surface. Embodiments of the method can further include disposing a second recessed portion in the substantially level portion of the top surface of the platform, the second recessed portion capable of receiving partially therein the inner tire of a second set of the multiple tires each on one or more of the wheels on a second axle of the vehicle, and disposing the second recessed portion in the top surface of the platform in the form of an arcuate surface. The method of making a platform can further include one or more of: coupling a first ramp to a first end of the platform or coupling a second ramp to a second end of the platform, projecting cleats from the bottom surface of the platform, abuttably joining a first platform section and a second platform section at a juncture plane between the first recessed portion and the second recessed portion. Embodiments can, but need not necessarily further include rotatingly engaging the first platform section and the second platform section at the juncture plane, the first and second platform sections rotating between an operable condition in which the first platform section and the second platform section abut at the juncture plane toward a storage condition in which the bottom surface of the first section abuts against the bottom surface of the second platform section. Particular embodiments of the method can include, releasably joining a pair of interlockable elements at the juncture plane to abut the first platform section with the second platform section. In particular embodiments releasably joining a pair of interlockable elements of a dovetail joint at the juncture plane to abut the first platform section with the second platform section or releasably joining a pair of interlockable elements of a pair of interleavable flanges at the juncture plane to abut the first platform section with the second platform section. Embodiments of the method can further include disposing patterned surface elements on the top surface, the first recessed portion, the second recessed portion, the first ramp, the second ramp, or the bottom surface.

Another broad object of the invention can be a method of raising a vehicle including at least two pairs of wheels correspondingly having two pairs of tires on at least one axle. The method includes engaging a bottom surface of a platform to a support surface, aligning a first inner tire with the platform, driving the first inner tire on a top surface of the platform to dispose the vehicle on the platform, suspending an outermost tire of the pairs of tires on the first axle above the support surface, attending to the outermost tire of the pairs of tires on the first axle, and driving the first inner tire of the pairs tires on the first axle on the top surface of the platform to dispose the vehicle off from the platform. The method of raising a vehicle can, but need not necessarily, further include locating the first inner tire within a first recessed portion or locating a second inner tire of a second pair of tires on a second axle of the vehicle within a second recessed portion. In particular embodiments in which the platform includes a first platform section and a second platform section which abut at a juncture plane between the first recessed portion and the second recessed portion, the method can further include connecting a pair of interlockable elements of the first or second platform section at a juncture plane, in which there is a first of the pair of interlockable elements disposed on the first platform section and a second of the pair of interlockable elements disposed on the second platform section. The method can, but need not necessarily, include disconnecting the pair interlockable elements at the juncture plane. In particular embodiments in which a hinge couples first and second platform sections, the method can further include hingedly rotating the first platform section and the second platform section of the platform toward a storage position abutting the bottom surface of the first platform section and the second platform section. In addition, the method can, but need not necessarily, include stowing the platform in the storage position in one piece. The method can, but need not necessarily, include stowing the first platform section and the section of the platform as discrete pieces.

Another broad object of the invention can be to provide a platform assembly including: a first platform section and a second platform section, each of the first and second platform sections further include a bottom surface and a top surface having a substantially level surface disposed between first and second ramps, in which the substantially level top surface includes a pair of recessed portions disposed in spaced apart relation between the first and second ramps. A pair of interlocking elements disposed at a junction plane between the pair of recessed portions are adapted to lock and unlock to dispose the first and the second platform sections between an operable condition and a storage condition.

### III. A BRIEF DESCRIPTION OF THE DRAWINGS

FIG. 1 is a perspective view of an embodiment of a platform for raising one or more tires of a vehicle having multiple wheels on one or more axles.

FIG. 2 is a perspective view of an embodiment of the platform for raising one or more tires of a vehicle having multiple wheels on one or more axles having first and second platform sections.

FIG. 3 is a perspective view of an embodiment of the platform for raising one or more tires of a vehicle having multiple wheels on one or more axles having first and second platform sections.

FIG. 4 is a perspective view of an embodiment of the platform for raising one or more tires of a vehicle having multiple wheels on one or more axles having first and second platform sections.

FIG. 5 is a perspective view of an embodiment of the platform for raising one or more tires of a vehicle having multiple wheels on one or more axles having first and second platform sections.

FIG. 6 is a perspective view of an embodiment of the platform for raising one or more tires of a vehicle having multiple wheels on one or more axles having first and second platform sections.

FIG. 7 is a perspective view of an embodiment of the platform for raising one or more tires of a vehicle having multiple wheels on one or more axles having first and second platform sections.

FIG. 8 is a side view of an embodiment of the platform having hingedly coupled first and second platform sections.

FIG. 9 is a top plan view of an embodiment of the platform for raising one or more tires of a vehicle having multiple wheels on one or more axles.

FIG. 10 is a bottom plan of an embodiment of the platform for raising one or more tires of a vehicle having multiple wheels on one or more axles.

FIG. 11 is first side view of an embodiment of the platform, illustrating an operating condition and a storage condition.

FIG. 12 is a second side view of an embodiment of the platform for raising one or more tires of a vehicle having multiple wheels on one or more axles.

FIG. 13 is a first end view of an embodiment of the platform for raising one or more tires of a vehicle having multiple wheels on one or more axles.

FIG. 14 is a second end view of an embodiment of the platform for raising one or more tires of a vehicle having multiple wheels on one or more axles.

FIG. 15 is a perspective view of an embodiment of the platform, illustrating patterned surface elements.

FIG. 16 is another perspective view of an embodiment of the platform, illustrating patterned surface elements.

FIG. 17 is another perspective view of an embodiment of the platform, illustrating patterned surface elements.

FIG. 18 is a side view of an embodiment of a platform for raising one or more tires of a vehicle having multiple wheels on one or more axles.

FIG. 19 is a top, rearward, perspective view of an embodiment of a platform for raising one or more tires of a vehicle having multiple wheels on one or more axles.

FIG. 20 is a top view of an embodiment of a platform for raising one or more tires of a vehicle having multiple wheels on one or more axles.

### IV. DETAILED DESCRIPTION

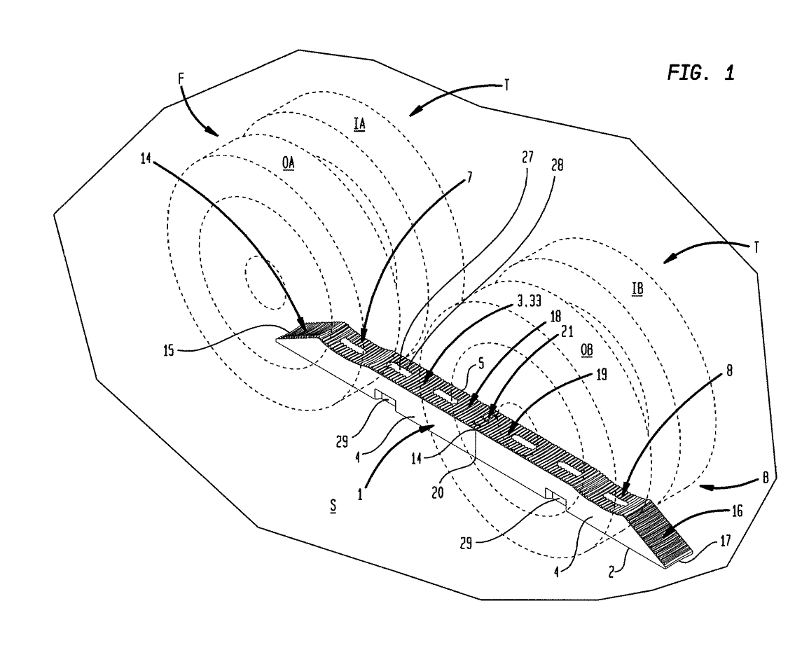

Now referring generally to FIGS. 1 through 20, a platform (1) for raising one or more tires (T) of a vehicle (V) having multiple wheels on one or more axles can include a bottom surface (2) having a configuration to engage a support surface (S), such as the ground, and a top surface (3). The platform (1) includes a first side wall (4) opposite a second side wall (5) which correspondingly join the bottom surface (2) to the top surface (3) of the platform (1). The length of the platform (1) can, but need not necessarily, be configured to accommodates both front (F) and back (B) sets of rear wheel tires (T) on dual axle vehicles, such as tractor of a combination tractor-trailer.

Now referring primarily to FIG. 1, in a particular embodiment, the top surface (3) can include a level portion (6). The level portion (6) can be a substantially flat and even surface generally without slope. A first recessed portion (7) can be disposed in the top surface (3), the first recessed portion (7) configured to receive partially therein an inner tire (IA) of a first set of the multiple tires correspondingly mounted on one or more wheels on a first axle of a vehicle (V).

Again, referring primarily to FIG. 1, in particular embodiments, a second recessed portion (8) can, but need not necessarily, be disposed in the top surface (3), the second recessed portion (8) configured to receive partially therein the inner tire (IB) of a second set of the multiple tires correspondingly mounted on one or more wheels on a second axle of the vehicle (V). First and second recessed portions (7), (8) can be disposed in the top surface (3) a distance apart which allows the first and second inner tires (IA), (IB) of the first and second set of the multiple tires correspondingly mounted on one or more wheels on the first and second axles of the vehicle (V) to correspondingly be received partially therein.

Again, referring primarily to FIG. 1, in particular embodiments, the first or second recessed portions (7), (8) (or both) can, but need not necessarily, be continuously arcuate having a radius of substantially equal length or of greater length than the radius of the corresponding first and second inner tires (IA), (IB) received partially therein with an arc measure of about 10 degrees to about 45 degrees.

Again, referring primarily to FIG. 1, in particular embodiments, the first or second recessed portions (7), (8) (or both) disposed in the top surface (3) can, but need not necessarily, include a recessed medial portion (9) disposed between opposed first and second recessed end portions (10), (11) which correspondingly extend from the level of the top surface (3) of the platform (1) to the level of the recessed medial portion (7). The first and second recessed end portions (10), (11) can, but need not necessarily, correspondingly provide first and second arcuate surfaces (12), (13) as shown in the examples of FIGS. 1 through 12); however, this illustrative example is not intended to preclude first and second recessed end portions (7), (8) which provide substantially flat or flat surfaces. In particular embodiments, the recessed medial portion (9) can have a length which corresponds to the variance in wheel base (WB) (the distance between the front and rear axle of tandem axels) over the variety of vehicles (V) used with embodiments of the platform (1). As one example, if the wheel base over the variety of vehicles (V) varies between 53 inches to 57 inches on center, then the length of the recessed medial portion (9) of the first and second recessed portions (7), (8) can be about 4 inches to about 6 inches in length. This allows the first and second inner tires (IA), (IB) of the first and second set of the multiple tires correspondingly mounted on one or more wheels on the first and second axles of the vehicle (V) to correspondingly be received within the first and second recessed portions (7), (8) regardless of variance in wheel base (WB) between 53 inches to 57 inches of different types of vehicles (V).

Again referring primarily to FIG. 1, in particular embodiments, the platform (1) can, but need not necessarily, include a first ramp (14) disposed at a platform first end (15) providing an inclined surface extending from the level of the bottom surface (2) to the level of the top surface (3) or a second ramp (16) disposed at a platform second end (17) providing an inclined surface extending from the level of the bottom surface (2) to the level of the top surface (3).

Again, referring primarily to FIG. 1, in particular embodiments, the platform (1) can be made in one-piece. In other particular embodiments, the platform (1) can, but need not necessarily, include first and second platform sections (18), (19), which releasably abut at a juncture plane (20).

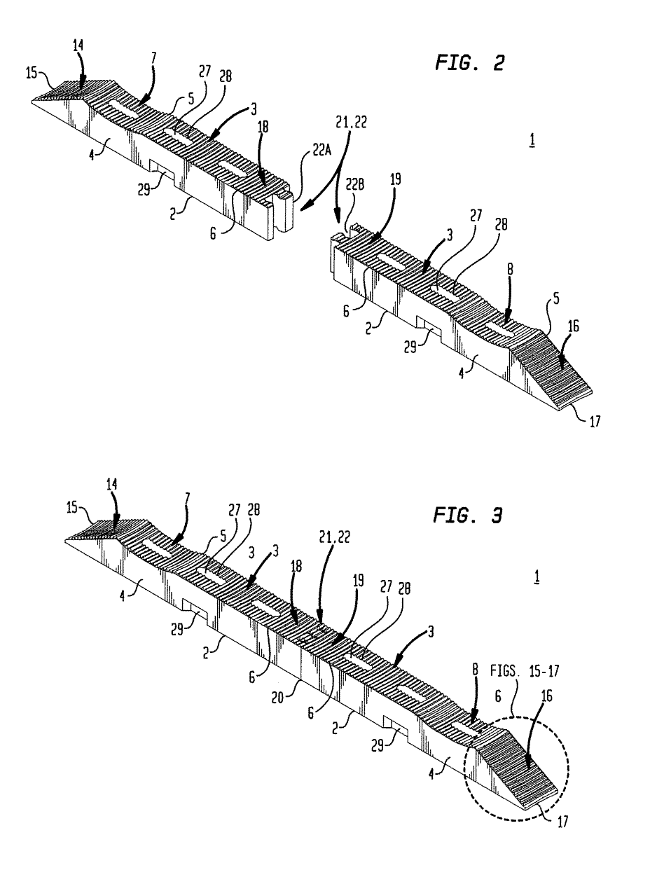

Now referring generally to FIGS. 2 through 7, the first and second platform sections (18), (19) can, but need not necessarily, further include interlockable elements (21) for integrally joining the first platform section (18) and the second platform section (19) at the juncture plane (20).

Now referring primarily to FIGS. 2 and 3 and 4 and 5, in particular embodiments, the first and second platform sections (18), (19) including the interlockable elements (21) can be created as substantially identical or identical structures, that when rotated 180 degrees, the symmetrical interlockable elements (21) can be releasably mated. This can advantageous in a few ways, the first being that only a single mold may be needed to produce both the first and second platform sections (18), (19), which can substantially reduce tooling cost. A second advantage can be that the inventory of a single part for both the first and the second platform sections (18), (19) can be more efficient and less expensive than for two different structures. A third advantage can be that having only one part design, not two, allows concurrent production of both the first and second platform sections (18), (19).

Now referring primarily to FIGS. 2 and 3, in an embodiment of the platform (1), the interlockable elements (21), can, but need not necessarily be configured as releasably mateable parts of a dovetail joint (22) formed by one or more tapered projections (tenons) (22A) on first platform section (18) that releasably interconnect with corresponding notches or recesses (mortises) (22B) in the second platform section (19). The integrally joined first and second platform sections (18), (19) shown in the example of FIG. 3 illustrates a platform (1) having first and second platform sections (18), (19) joined in an operable condition, while corresponding FIG. 2, illustrates the first and second platform sections (18), (19) separated in a storage condition.

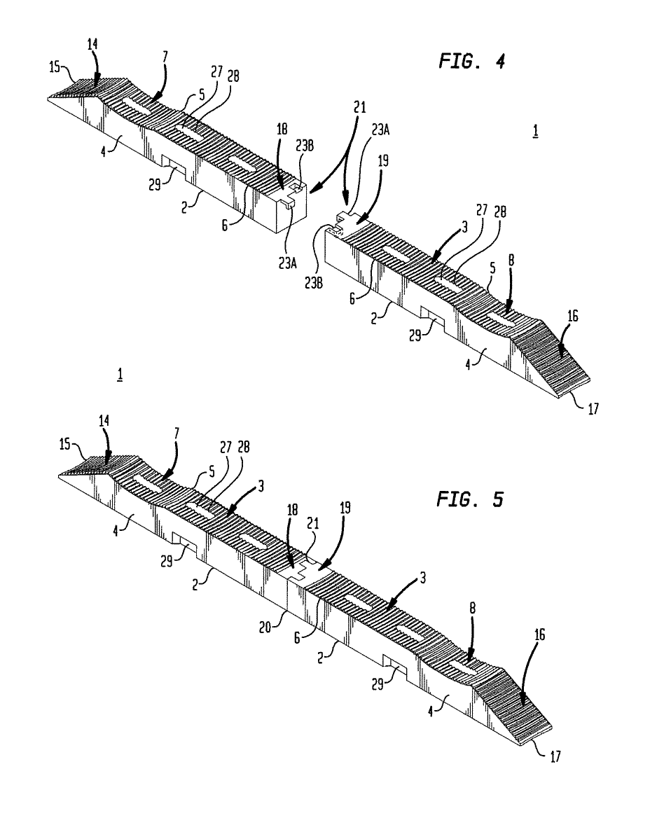

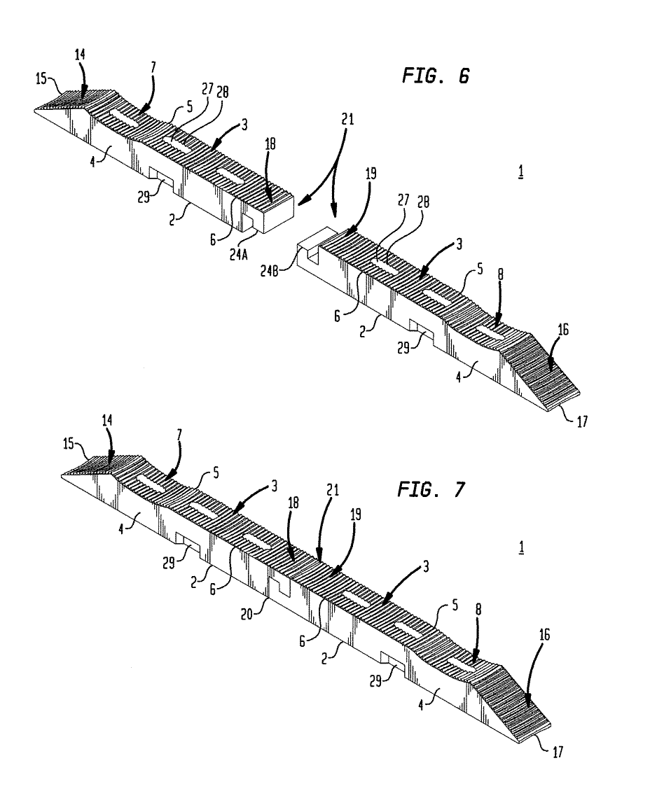

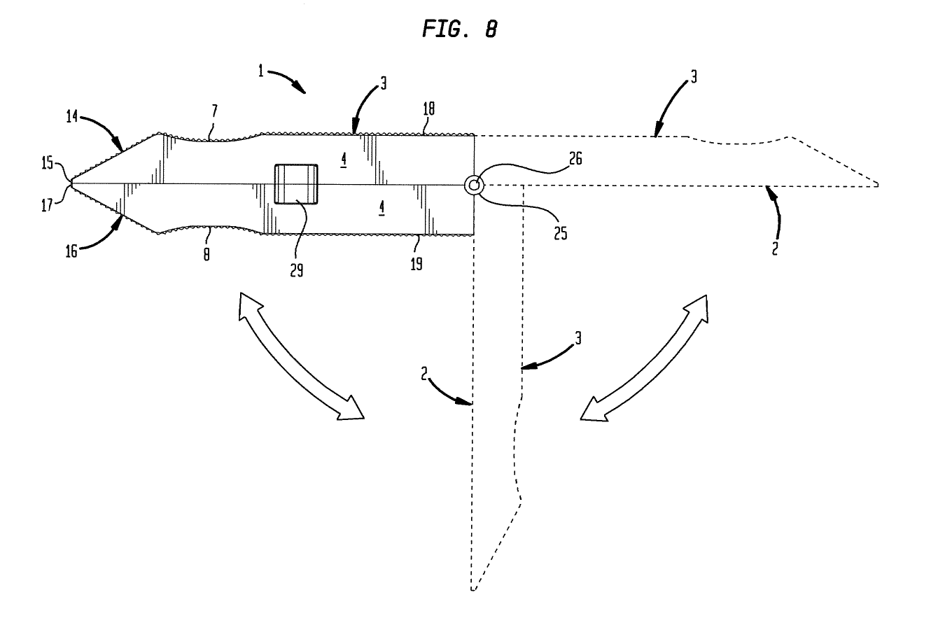

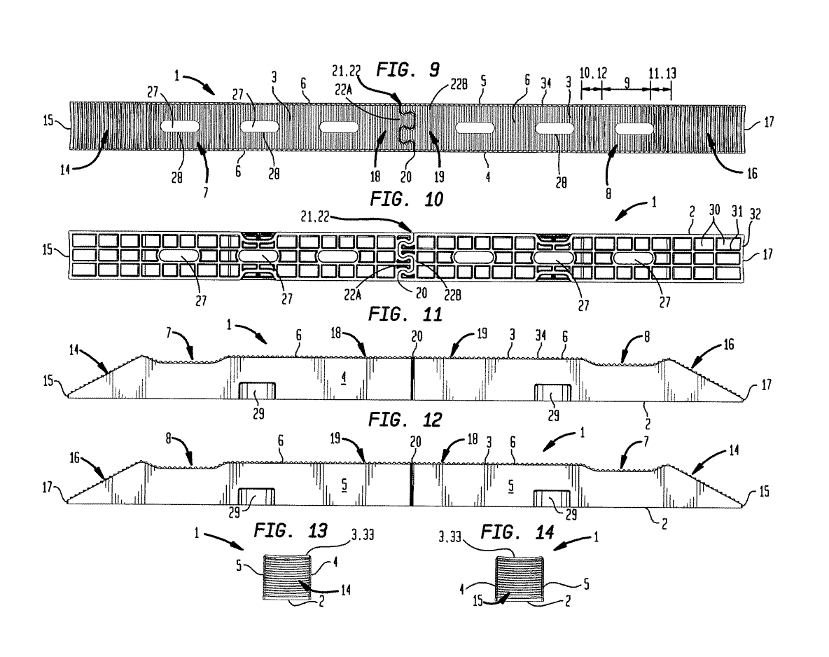

Now referring primarily to FIGS. 4 and 5, in another embodiment, interlockable elements (21) can be configured as one or more flanges (23A) which matably join one or more receiving slots (23B). The integrally joined first and second platform sections (18), (19) shown in the example of FIG. 5 illustrates a platform (1) having first and second platform sections (18), (19) joined in an operable condition, while corresponding FIG. 4, illustrates the first and second platform sections (18), (19) separated in a storage condition.

Now referring primarily to FIGS. 6 and 7, in another embodiment, the pair of interlockable elements (21) can comprise a pair of interleavable flanges (24A), (24B) which matably interleave to abut the first platform section (12) with the second platform section (13). The integrally joined first and second platform sections (18), (19) of FIG. 7 illustrates a platform (1) in an operable condition, while corresponding FIG. 6, illustrates the first and second platform portions (18), (19) separated in the storage condition configuration.

Now referring primarily to FIG. 8, the platform (1) can, but need not necessarily include a hinge (25) for pivotally connecting first and second platform portions (18), (19). Hinge (25) can, but need not necessarily, include a pivot element (26), defining a rotation axis disposed at juncture plane (20) at which the first platform section (18) abuts with the second platform sections (19). The first and second platform sections (18), (19) can rotate about the rotation axis of the pivot element (26) allowing the platform (1) to pivot between the operable condition and the storage condition in which the bottom surface (2) of the first platform section (18) abuts the bottom surface (2) of the second platform section (19). While the hinge (25) shown in the illustrative embodiment of FIG. 8 includes a pivot element (26), this is not intended to preclude a hinge (25) in the form of a living hinge providing a thin flexure bearing material which interconnects the first and second sections (18), (19) of the platform (1) allowing the first and second platform sections (18), (19) of the platform (1) to rotate between the operable condition and the storage condition.

The illustrative examples of FIGS. 2 through 8, are not intended to preclude other embodiments of interlocking elements (21) or other type of mechanical fasteners, latches or locks which integrally join the first and second platform sections (18), (19) proximate the juncture plane (20).

Now referring primarily to FIG. 9 through FIG. 14, and with continuing reference to FIG. 1, in particular embodiments, the platform (1) includes sidewalls (4), (5). Sidewalls (4), (5) provide vertical support of the top surface (3) at a height of about three inches to about six inches above a support surface (S), such as the ground. This allows the outermost tires (OA), (OB) to be free and clear of the support surface (S) when the inside tires (IA), (IB) are disposed on the top surface (3) of the platform (1). The length and width (about the width of a single tire on a pair of dual rear wheel tires) of the platform (1) provides sufficient surface area on the top surface (3) to allow a vehicle (V) to mount and dismount the platform (1), and sufficient surface area on the bottom surface (2) of the platform (1) to resist or prevent the platform (1) from sliding out from underneath the tires (T) of the vehicle (V).

Now referring primarily to FIG. 9, in particular embodiments, one or more apertures (27) can communicate through the top surface (3) or in the first or second recessed portions (7), (8) to provide a passthrough for liquid to reduce or prevent collection of the liquid on the top surface (3) of the platform (1) or to provide a first set of hand holds (28) for movement of the platform (1) or platform first and second sections (18), (19).

Now referring primarily to FIGS. 10 through 12, in particular embodiments, a second set of handholds (29) can, but need not necessarily, be disposed on or in the sidewalls (4), (5) of the platform (1). The particular example of FIGS. 10 through 12, illustrates the second set of handholds (29) formed as a pair of hollow recesses correspondingly oppositely disposed in sidewalls (4), (5).

Now referring primarily to FIG. 10, in particular embodiments, the platform (1) or the first and second platform portions (18), (19) including the top surface (3), the side walls (4), (5) and optionally the first and second ramps (14), (16) and interlockable elements (21) can, but need not necessarily, be concurrently integrally formed as one piece by means of injection molding. The volume enclosed by the top surface (3), the side walls (4), (5) and optionally the first and second ramps (14), (15) and interlockable elements (21) can, but need not necessarily, be divided into a plurality of open-ended compartments (30) by means of a plurality of panels or partitions (31) which are integrally connected to the top surface (3) and the side walls (4), (5) and optionally the first and second ramps (14), (16) and interlockable elements (21). The open-ended compartments (30) disposed in the platform (1) confer the advantage of using less material to form the platform (1) and correspondingly lesser platform weight.

Again, referring primarily to FIG. 10, embodiments of the platform (1) including a plurality of interconnected panels or partitions (31), afford a bottom surface (2) including interconnected panel edges (32) which can be engaged with the support surface (S). The interconnected panel edges (32) can afford the advantage of increasing purchase to the support surface (S). The illustrative example of FIG. 10 is not intended to preclude embodiments in which the platform has an open volume and the bottom surface (2) comprises one or more bottom panels which provide an entirely or partial continuous unbroken bottom surface (2).

Now referring primarily to FIGS. 13 and 14, in particular embodiments, the top surface (3) can, but need not necessarily, further comprise a concave arcuate top surface (3), (33) disposed between the sidewalls (4), (5) of the platform (3). The concave arcuate top surface (3), (33) can afford the advantage of urging the first and second inner tires (IA), (IB) toward the longitudinal center of the platform (1).

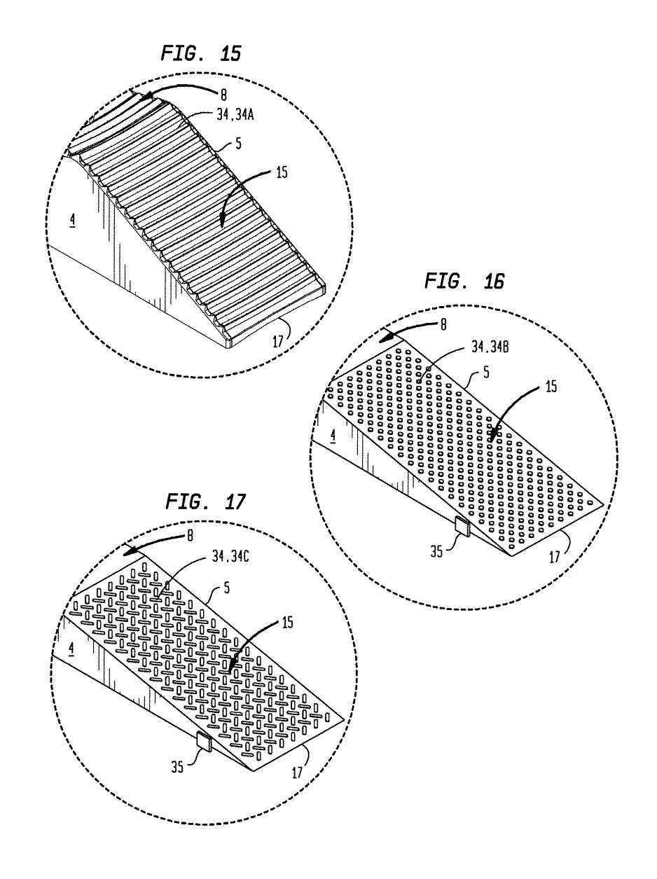

Now, referring primarily to FIGS. 15 through 17, and with continuing reference to FIGS. 1 through 14, patterned surface elements (34) can, but need not necessarily, be disposed on the top surface (3) (or other surfaces of the platform (1)) to provide increased traction of the tires (T) as vehicle (V) mounts and dismounts the platform (1). Patterned surface elements (34) can comprise raised or recessed liner ribs (34A) (as shown in the illustrative example of FIGS. 1 and 15), a raised or recessed dimple pattern (34B) (as shown in the illustrative example of FIG. 16), a raised or recessed cross hatch pattern (34C) (as shown in the illustrative example of FIG. 17), a diamond pattern, or other raised or recess surface elements which increase traction or reduce slip of the tires (T) on the platform (1).

Again, referring to FIG. 16 or 17, in particular embodiments, cleats (35) can, but need not necessarily, be stationed at intervals along the length of the platform (1) and extending outward of the bottom surface (2) or sidewalls (4), (5) of the platform (1) a sufficient distance to resist or prevent the platform (1) from sliding out from underneath the tires (T) of the vehicle (V). In particular embodiments, the cleats (35) can be constructed as a feature integral with the sidewalls (4), (5) or bottom surface (2) when molded, or joined to the sidewalls (4), (5) or bottom surface (2) when fabricated. As one example, the cleats (35) can be carbide-tipped studs that are rust and corrosion resistant.

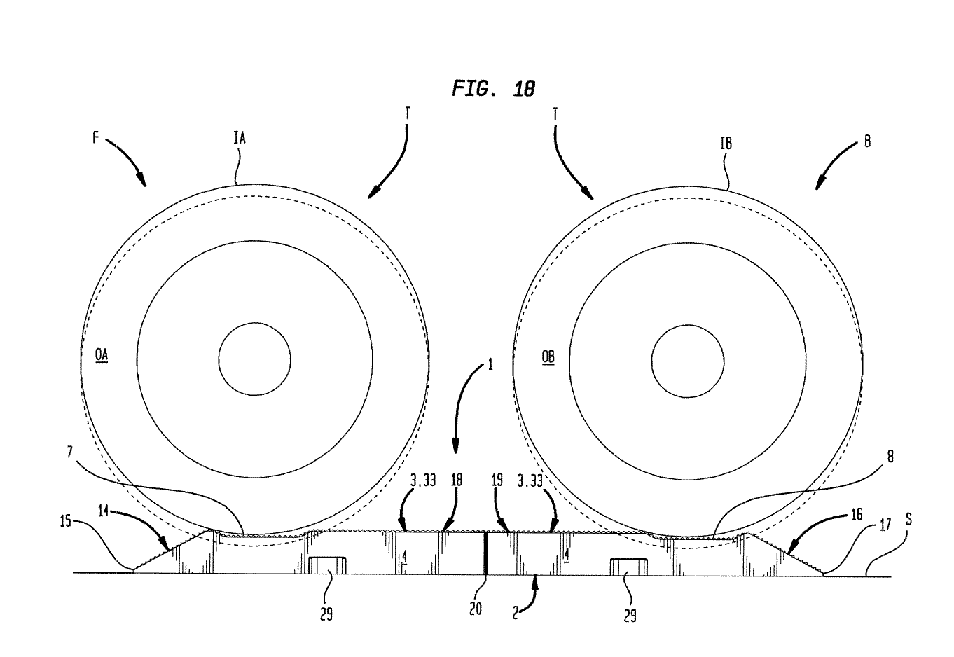

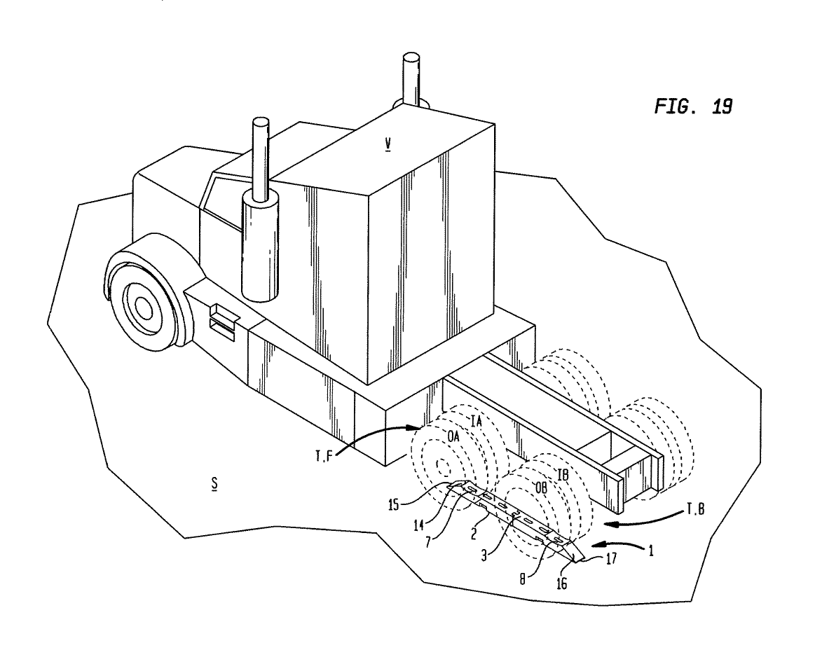

Now referring primarily to FIG. 18 through FIG. 20, illustrative of a method of using embodiments of the platform (1) to enable one person to suspend the outermost tires (OA), (OB) of a vehicle (V) having tandem rear wheel tires or multiple tandem rear wheel tires above a support surface (S), such as road pavement. Particularly useful during inclement weather, the platform (1) can be used by a driver of a vehicle (V) to quickly perform snow chain installation on a suspended outermost tire (OA), (OB). The drive-on platform (1) can also be used to change a flat tire and or replace an outermost tire (OA), (OB), or otherwise service outermost tire (OA), (OB) or corresponding axles.

In FIG. 18, the platform (1) can be disposed in the operable condition by engaging a bottom surface (2) of the platform (3) to a support surface (S). Front (F) and back (B) sets of rear wheel tires (T) include outermost (OA and OB) and inner (IA and IB) tires within the front (F) and back (B) tire (T) pair sets.

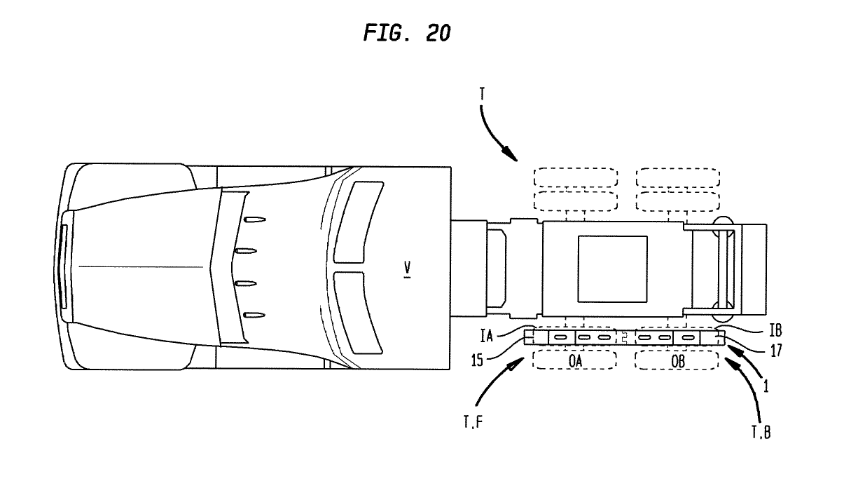

Next, referring primarily to FIGS. 19 and 20, embodiments of the method further include aligning a first inner tire (IA) of the two pairs of tires on the two pairs of wheels on a first axle of with the linear pathway of the platform (1). Upon driving the first inner tire (IA) onto the top surface to mount the vehicle on the platform (1) thereby suspending an outermost tire of the two pairs of tires above said support surface (S), the method can further include attending to the outermost tire of the two pairs of tires on the two pairs of wheels on each of the pair of axles, and driving the first inner tire on the top surface of said platform to dismount the vehicle (V) from the platform (1).

Again, referring primarily to FIGS. 18 through 20, embodiments of the method can further include driving the inner tires (IA), (IB) on the top surface (3) of the platform (1), thereby locating each inner tire (IA and IB) within the corresponding first and second recessed portions (8), (9), respectively.

Now referring primarily to FIGS. 18 through 20, with continued reference to FIGS. 2 through 8, the method can further include reconfiguring the platform (1) between the operable condition to the stowed condition. In reference to the embodiments shown in FIGS. 2 through 7, the method can further include connecting a pair of interlockable elements (21) or disconnecting a pair interlockable elements (21) at a juncture plane (20), with a first of said pair of interlockable elements (21) disposed on said first platform section (18) and a second of said pair of interlockable elements (21) disposed on said second platform section (19), and stowing the first platform section (18) and the second platform section (19) as discrete pieces. In reference to the embodiment of FIG. 8, the method can further include hingedly rotating the first platform section (18) and the second platform section (19) of the platform (1) toward a storage condition which abuts the bottom surface (2) of said first platform section (8) against the bottom surface (2) of the second platform section (19).

Various embodiments further include raising a tire or tires in accordance with the foregoing description of the drive-on platform (1).

As can be easily understood from the foregoing, the basic concepts of the present invention may be embodied in a variety of ways. The invention involves numerous and varied embodiments of a system for conducting a performance analysis of a radio frequency generator and methods for using such a system and the component parts including the best mode.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “interlockable elements” should be understood to encompass disclosure of the act of “interlocking elements”—whether explicitly discussed or not—and, conversely, were there effectively disclosure of the act of “interlocking elements”, such a disclosure should be understood to encompass disclosure of a “interlockable elements” and even a “means for interlocking elements.” Such alternative terms for each element or step are to be understood to be explicitly included in the description.

In addition, as to each term used it should be understood that unless its utilization in this application is inconsistent with such interpretation, common dictionary definitions should be understood to be included in the description for each term as contained in the Random House Webster's Unabridged Dictionary, second edition, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Moreover, for the purposes of the present invention, the term “a” or “an” entity refers to one or more of that entity unless otherwise limited. As such, the terms “a” or “an”, “one or more” and “at least one” can be used interchangeably herein.

Thus, the applicant(s) should be understood to claim at least: i) each of the platforms disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

Additionally, the claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. A platform for supporting an inner tire within a set of multiple tires on an axle of a vehicle having one or more sets of multiple tires each on one or more wheels on one or more axles, said platform supporting said inner tire to suspend an outermost tire of said set of multiple tires above a support surface, comprising:
a bottom surface of said platform configured to engage said support surface; and
a top surface of said platform having a substantially level portion, and a first recessed portion disposed in said top surface capable of receiving partially therein said inner tire of a first set of said multiple tires each on said one or more wheels on a first axle of said one or more axles of said vehicle.

2. The platform of claim 1, wherein said top surface further comprises a second recessed portion disposed in said top surface capable of receiving partially therein said inner tire of a second set of said multiple tires each on said one or more wheels on a second axle of said one or more axles of said vehicle.

3. The platform of claim 2, further comprising a first ramp coupled to a first end of said platform.

4. The platform of claim 3, further comprising a second ramp coupled to a second end of said platform.

5. The platform of claim 4, further comprises patterned surface elements disposed on one of one or more of said top surface, said first recessed portion, said second recessed portion, said first ramp, and said second ramp.

6. The platform of claim 5, further comprising cleats projecting from said bottom surface.

7. The platform of claim 1, wherein said platform comprises a first platform section and a second platform section which abut at a juncture plane between said first recessed portion and said second recessed portion.

8. The platform of claim 7, further comprising a hinge about which said first platform section and said second platform section rotate between an operable condition in which said first platform section and said second platform section abut at said juncture plane toward a storage condition in which said first platform section and said second platform section abut said bottom surface of said first platform section against said bottom surface of said second platform section.

9. The platform of claim 7, further comprising a pair of interlockable elements which releasably join to abut said first platform section with said second platform section at said juncture plane.

10. The platform of claim 7, wherein said pair of interlockable elements comprise mateable portions of a dovetail joint.

11. The platform of claim 7, wherein said pair of interlockable elements comprise a pair of interleavable flanges.

12. The platform of claim 7, wherein said pair of interlockable elements comprise mateable portions of a flange and a receiving slot.

13. The platform of claim 2, wherein said first and second recessed portions further comprise recessed arcuate surfaces.

14. The platform of claim 2, wherein said first and second recessed portions further comprise a recessed medial portion disposed between opposed first and second recessed end portions which correspondingly extend from the level of the top surface of the platform to the level of the recessed medial portion.

15. The platform of claim 14, wherein said recessed medial portion has a length between said first and second recessed end portions which corresponds to the variance in distance center to center between said axels.

16. The platform of claim 15, wherein said recessed medial portion has a length between said first and second recessed end portions of between about 4 inches to about 6 inches.

17-42. (canceled)
